(19) United States
(12) Patent Application Publication
(10) Pub. No.: US 2011/0181276 A1
(43) Pub. Date: Jul. 28, 2011

(54) Metal detector utilizing combined effects of modified flux linkage and oscillator excitation current

(75) Inventor: Sergey A. Moskalenko, Maple Grove, MN (US)

(73) Assignee: THERMO FISHER SCIENTIFIC

(21) Appl. No.: 12/657,755

(22) Filed: Jan. 25, 2010

(51) Int. Cl. G01N 27/82

(52) U.S. Cl. 324/240

(57) ABSTRACT

A first coil configuration (106) for use with a radio frequency metal detector includes a parallel wound oscillator coil (42) having two planar loops (43, 44). An oscillator excitation voltage (46) is applied simultaneously across both planar loops 43. The amount of induced voltage in two adjacent receiving loops (48, 49) is increased by closely spacing the oscillator coil loop (44) to one receiving loop (49) and by closely spacing the oscillator coil loop (43) to the other receiving loop (48). A second coil configuration (107) is a series aiding oscillator coil (55) having two planar loops (108, 54). The series aiding coil arrangement increases the oscillator current by decreasing the inductance of the oscillator coil (55) when a conductive contaminant (18) crosses the plane of the oscillator coil. The receiving or input coil (60) is formed of two separate loops (56, 57) wound in serial opposition to each other. A third coil configuration (75) includes an oscillator coil (77) having at least four planar loop elements (76, 78, 79, 80). Each of the three coil configurations simultaneous utilize the effect of a modification of oscillator current and a modification of flux linkage between the coils to increase the sensitivity of a metal detector when a conductive contaminant (18) is introduced into the region of the coils.

### BACKGROUND OF THE INVENTION

1. Field of Invention

This invention pertains generally to the field of radio frequency metal detectors, and more particularly to such devices as used in real time food processing environments.

2. Description of Prior Art

Metal detectors are used in the food processing industry, for example, to detect contaminants within a product. The unwanted material may include very small metallic particles having differing compositions. As seen in FIG. 1, the typical metal detector is housed in an enclosure 1 containing a longitudinal aperture 2 through which the product under test 3 is transported, usually by means of a conveyor belt 4, in the direction of arrow 5. The metal detector includes a radio frequency transducer or oscillator that radiates a magnetic field by means of some arrangement of electrical conductors that serve as a radio frequency transmitting antenna, the radiated signal being detected by another arrangement of conductors that serve as a receiving antenna. If a metal contaminant is introduced into a space between the transmitting and receiving antennas, the characteristic of the signal detected by the receiving antenna will be altered when compared to a signal detected by the receiving antenna in the absence of a metal contaminant. An example of a metal detector operating in the radio frequency range is disclosed in U.S. Pat. No. 5,994,897, entitled FREQUENCY OPTIMIZING METAL DETECTOR, issued on Nov. 30, 1999 to King.

The simplest type of metal detector as illustrated in FIG. 2 includes only two parallel conductors 6 and 7 separated by a distance 85, referred to as “a” in the following equations. The conductor 6 is excited by an oscillator which generates a current i(t)=Iₘₐₓ cos(α)=I, flowing in the direction indicated by arrow 9, thereby creating an average magnetic flux B_{avg} as indicated by the arrow 8. The magnitude of B_{avg} is a function of the instantaneous current I(t). The flux density B as indicated on the axis 10 at any distance 13 from the center 11 of the conductor 6 is defined by the expression B=(μi)/(2πr), where r is the radius 12 of the conductor 6 and μ is the permeability of the conductor material.

In the presence of the magnetic flux B a voltage V_{ind} is induced along the length 14 of the passive conductor 7 and can be expressed as V_{ind}=d φ₍ₜ₎/dt=(t), where

Φ=ᵣ∫^{a}Bdr=ᵣ∫^{a}[(μi)/(2πr)]dr=(μi)/(2π)ᵣ∫^{a}dr/r=[(μi)/(2π)]log a/r and

φ₍ₜ₎=[(μ)/(2π)](log a/r)i(t) or φ₍ₜ₎=[(μ)/(2π)](log a/r)(Iₘₐₓ sin(α+90).

Accordingly,

V_{ind}=[(μ)/(2π)](log a/r)(Iₘₐₓ sin(α+90), where

V_{ind} is the voltage induced in the parallel passive conductor 7 and is a function variables i(t), the current flowing in the active conductor 6, “a”, the distance between the conductors 6 and 7, μ, the permeability of the conductors, and B, the flux density generated by the conductor 6 which is also a function of i(t). Accordingly, V_{ind}=f(B(i), a, μ).

As seen in FIG. 3, the oscillator coil or transmitting antenna 15 may be formed as a continuous, planar wire loop residing within the enclosure 1. The oscillator coil 15 surrounds the aperture 2 and receives radio frequency excitation 90 or Vᵢₙ from an oscillator circuit causing a current i(t) to flow in the direction of arrow 17. The enclosure 1 also contains a parallel, planar receiving coil 16. The loops 15 and 16 are separated by the distance 87 or “a”. The excitation voltage Vᵢₙ induces a voltage 91 or V_{ind} in the receiving coil 16 having a value of

V_{ind}=n(dB/dt)A, where

n=1

B=[(μi(t))/(2πa)] and

A=the area enclosed by the single loop 15.

Substituting the values disclosed in describing the physical relationships depicted in FIG. 2, V_{ind}=A(μ)/(2πa)](di(t)/dt)=[(μ)/(2πa)](Iₘₐₓ sin(α)) A or V_{ind}=[(μ)/(2πa)]AIₘₐₓ sin(α).

Accordingly, V_{ind}=f(B(i), a, A, μ).

A disturbance in the radiated magnetic field is sensed by the receiving coil and processed in order to detect a metal contaminant within the product passing through the detector aperture. FIG. 4 depicts the two parallel rectangular loops 15 and 16 and their physical relationship to a metal contaminant 18 residing between the two loops. The location of the contaminant 18 is determined by its position 92 along the vertical axis 19, location 24 on the horizontal axis 20 and the coordinate 93 along the depth or “z” axis 21. As stated previously for the general case presented in FIG. 3 with an oscillator voltage 90, the induced voltage in the receiving coil existing between the points indicated by line 22 is V_{ind}=n(dB/dt)A. In the case where the metal contaminant 18 is present, the total magnetic flux density Bₜₒₜₐₗ is a superposition of the flux density of the primary field B indicated by arrow 23 that is being generated by the transmitting loop 15, and the flux density B_{eddy} generated by the induced eddy currents in the conductive material that is present in the metal contaminant 18 which resides in the primary flux field 23. The expression for the voltage induced in receiving coil 16 is

V_{ind}=(dBₜₒₜₐₗ/dt)A*, where

Bₜₒₜₐₗ is the summation of primary field B and B_{eddy} and

A* is the area enclosed by the loop 16 which in practice is substantially equal to the area enclosed by the aperture 2.

The flux density of the primary field B may be expressed as B=+[(μi(t))/(2πa)], while the flux density of B_{eddy}=−[(μi_{eddy}(t))/(2π(a−d))], where

i_{eddy} is the eddy current induced in the metal contaminant 18 by the alternating magnetic field B, and is a function of the physical position of the contaminant 18 with respect to the axes 19, 20 and 21, as well as the magnitude of the magnetic field B, the physical shape or geometry of the contaminant 18, the conductivity of the metal within contaminant 18, and the frequency of the oscillator signal generating the magnetic field B; “d” is the distance indicated by arrow 24, which is the distance along the horizontal axis 20 between the contaminant 18 and the transmitting loop 15; and “a” is the distance between loops 15 and 16 as indicated by arrow 25. Therefore,

Bₜₒₜₐₗ=B+B_{eddy}=[μ/(2πa)](i(t)−[a/(a−d)]i_{eddy}(t)).

The induced voltage in receiving loop 16 can then be expressed as

V_{ind}=(dBₜₒₜₐₗ/dt)A=A[μ/(2πa)](Iₘₐₓ sin(α+90)−[a/(a−d)I_{max eddy} sin α])=V_{ind}=A[μ/(2πa)](I−[a/(a−d)I_{eddy}).

In the absence of the metal contaminant 18, the induced voltage in receiving coil 16 is a function of μ, a, A and the magnetic field current “i” which is flowing through the transmitting coil 15 in the direction indicated by arrow 26. In general, any metal detector based on the laws of electromagnetic induction will rely directly or indirectly on these parameters. In the case where the metal contaminant 18 is present, the induced voltage in the receiving coil 16 is a function of μ, a, A, the magnetic field current “i” as well as the eddy current I_{eddy}, which is itself a function of the magnitude of the transmitted flux 23, the position of the contaminant 18 with respect to the coils 15 and 16, the geometry of the contaminant 18, the conductivity of the contaminant and the oscillator frequency. As a practical matter, the typical metal detector will rely primarily on the magnetic field current 26, the distance 25 separating the coils, and rarely the permeability μ.

The next step in the evolution of the metal detector is shown in FIG. 5, where a single oscillator coil 27 is located between the planar loops 28 and 29 of a single series receiving coil 30. The distances 31 and 32 are substantially equal. The conveyor 4 transports material through the coils moving initially from the left hand receiving loop 28, past the oscillator coil 27 and continuing toward and beyond the right hand receiving loop 29. FIG. 6 depicts the equivalent electrical circuit corresponding to the physical geometry of FIG. 5. The oscillator excitation voltage 33 is characterized by parameters including the oscillator capacitance 34, the oscillator inductance 35 and the resultant oscillator current 36. A first induced voltage V_{ind1} and a first induced current I_{ind1} exist in the left hand coil 28 due to its proximity to the oscillator coil 27, and a second induced voltage V_{ind2} and a second induced current I_{ind2} also exist in the right hand coil 29. The induced voltages and currents act across a receiving coil capacitance 37, generating an output voltage 38 which can be characterized as Vₒᵤₜ=V_{ind1}+V_{ind2}.

The effect of the contaminant 18 passing through the array of coils can best be appreciated with reference to FIG. 7. The initial position 39 of the contaminant 18 along the distance axis 94 is within the plane of the left receiving loop 28, causing V_{ind1} to assume an arbitrary intermediate value marked 41. As the contaminant advances to position 43, corresponding to a point that is substantially equidistant from the plane of the oscillator coil 27 and the plane of the left receiving loop 28, the magnitude of V_{ind1} has reached a peak change in value 44 corresponding to a minimum magnitude 42. By the time the contaminant 18 reaches point 40, corresponding to a point that is within the plane of the oscillator coil 27, the magnitude of V_{ind1} has again returned to the value 41. As the contaminant 18 reaches position 45, corresponding to the center of the right receiving loop 29, the magnitude of V_{ind1} is approaching its steady state value 105.

When the initial position 39 of the contaminant 18 is within the plane of the left receiving loop 28, V_{ind2} is still near its steady state value 47. As the contaminant advances to position 43, corresponding to a point that is substantially equidistant from the plane of the oscillator coil 27 and the plane of the left receiving loop 28, the magnitude of V_{ind2} has begun a decrease in magnitude and reached an arbitrary value 50. By the time the contaminant 18 reaches point 40, corresponding to a point that is within the plane of the oscillator coil 27, the magnitude of V_{ind2} has further decreased to the value 51. As the contaminant 18 reaches position 48, corresponding to a point that is substantially equidistant from the plane of the oscillator coil 27 and the plane of the right receiving loop 29, the magnitude of V_{ind2} has reached a peak change in value 49 corresponding to a minimum value 52. As the contaminant 18 reaches position 45 corresponding to the center of the right receiving loop 29, the magnitude of V_{ind2} is again increasing.

The final curve shows the oscillator current, which peaks at an arbitrary value 53 when the contaminant 18 is at position 40 corresponding to the center of the oscillator coil 27. There are two major effects demonstrated by the voltage and current curves. First, the reduction in induced voltages in the left and right receiving coils caused by the presence of the contaminant is due to the reduction of flux linkage between the oscillator coil 27 and the receiving loop nearest the contaminant 18. As earlier described, eddy currents induced in the contaminant create an opposing magnetic flux which leads to a reduction of the flux linkage. The second effect is shown by the peak in oscillator current as the contaminant reaches the plane of the oscillator coil 27. The presence of the conductive contaminant near the oscillator coil reduces the inductance of the oscillator coil, thereby increasing the current passing through the oscillator coil according to Ohm's law. The oscillator current peak is also affected by the opposing induced eddy current within the contaminant 18 which reduces the absolute magnitude of the primary magnetic field generated by the oscillator coil.

The ultimate goal of the metal detection process is to maximize the magnitudes 44 and 49 representing the change in induced voltage in response to the presence of the contaminant 18. While the coil arrangement depicted in FIGS. 5 and 6 offers the advantages of simplicity, ease of assembly and relatively low oscillator coil input impedance, there are two separate undesirable effects that occur when actually used in the presence of a metal contaminant. First, there is a reduction in the flux linkage or mutual inductance between each receiver coil loop and the oscillator coil. Second, the current consumption of the oscillator coil increases due to the inductance reduction attributable to eddy current effects. Further, the inductance may actually increase if the magnetic permeability μ of the contaminant is greater than one, thereby causing a reduction of current in the oscillator coil.

A major disadvantage of the foregoing coil arrangement is that it relies only on the flux linkage increase or decrease that occurs in the presence of a metal contaminant. Further, a contaminant may be substantially nonconductive and still affect the flux linkage and oscillator current. In the case where the permeability of the contaminant is significantly greater than one, both the flux linkage and inductance of the oscillator coil will increase, causing an effect that is opposite to the normal effect of an induced eddy current, namely, where the conductivity of the contaminant determines the magnitude of the induced eddy currents. Conceivably a situation could occur where these two effects would cancel the other and a contaminant with a high permeability and a high conductivity would pass through the metal detector unnoticed.

As seen in FIG. 7, the oscillator coil 27 is equidistant from the left and right hand receiving loops. Thus, any change in the oscillator coil current has a substantially equal effect on both receiving loops and since the receiving loops are in a series opposition configuration, the effect of oscillator coil current changes is effectively cancelled. Induced voltage in the receiving coil reaches a minimum when a conductive contaminant is located somewhere between the plane of the receiving coil loop and the plane of the oscillator coil loop. At the same time the oscillator current as the contaminant approaches the plane of the oscillator coil. These two behaviors tend to counteract each other because as the induced voltage decreases, the rising oscillator current tends to increase the magnitude of the induced voltage. In prior art metal detectors the distances 31 and 32 between the plane of the oscillator coil 27 and the plane of the receiving loops 28 and 29 was determined empirically in an attempt to separate the two opposing effects and simply ignore the modification of the oscillator coil current which was considered an obstacle to metal detector sensitivity.

Therefore, a need exists to improve the design protocol for selecting coil geometries in metal detectors in order to take advantage of both flux linkage variations as well as oscillator current variations when utilizing multiple coils in various configurations. Multiple coil metal detectors have been disclosed in the past, including the configurations shown in U.S. Patent Publication No. 2004/0155651 A1, entitled FLUX CONTROL SYSTEM FOR METAL DETECTORS published on Aug. 12, 2004 and U.S. Patent Publication No. 2008/0055080A1, entitled OSCILLATOR COIL GEOMETRY FOR RADIO FREQUENCY METAL DETECTORS, published on Mar. 6, 2008. However, both of these disclosures depend only on empirical observations and offer no insight into an automated, predictable method of designing a multiple coil metal detector to achieve or optimize a desired characteristic that effectively utilizes both flux linkage and oscillator current effects.

### SUMMARY OF THE INVENTION

The current invention relates to improvements in detecting the effect of a metal contaminant when a product is undergoing inspection by a metal detector. The present invention improves the sensitivity of the detector for metals by creating a design protocol that utilizes both the effects of a modified flux linkage and a modified oscillator coil current to detect the presence of a metal contaminant. A second feature of the present invention addresses the design of an oscillator coil formed of one or more parallel pairs of loops. The oscillator coil resides between an input or receiving coil formed of two loops spaced apart from the oscillator coil. A third aspect of the invention addresses the design of an oscillator coil formed of two additive serial loops with each loop in a closely spaced relationship with a corresponding loop of the receiving or input coil. A fourth aspect of the invention addresses the design of an oscillator coil formed of four or more opposing serial loop elements.

### BRIEF DESCRIPTION OF THE DRAWINGS

FIG. 1 is a simplified perspective view of a prior art metal detector;

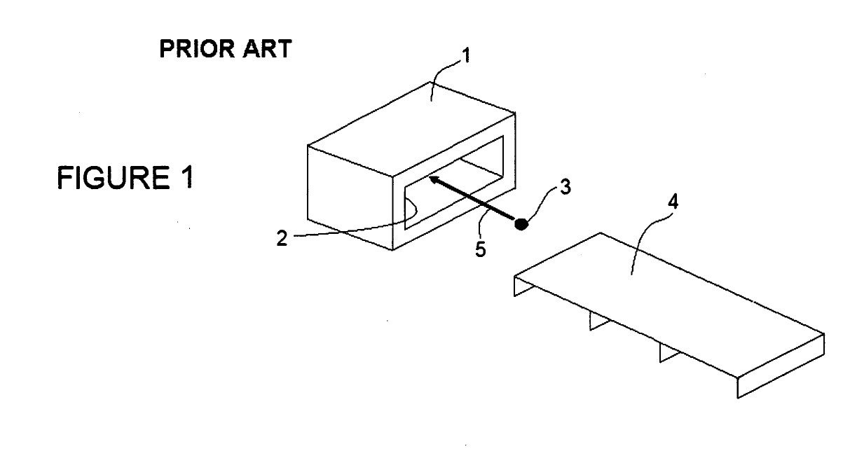

FIG. 2 is a prior art depiction of a graph oriented with a perspective view of two conductors to illustrate the variation of flux density with distance from the two conductors;

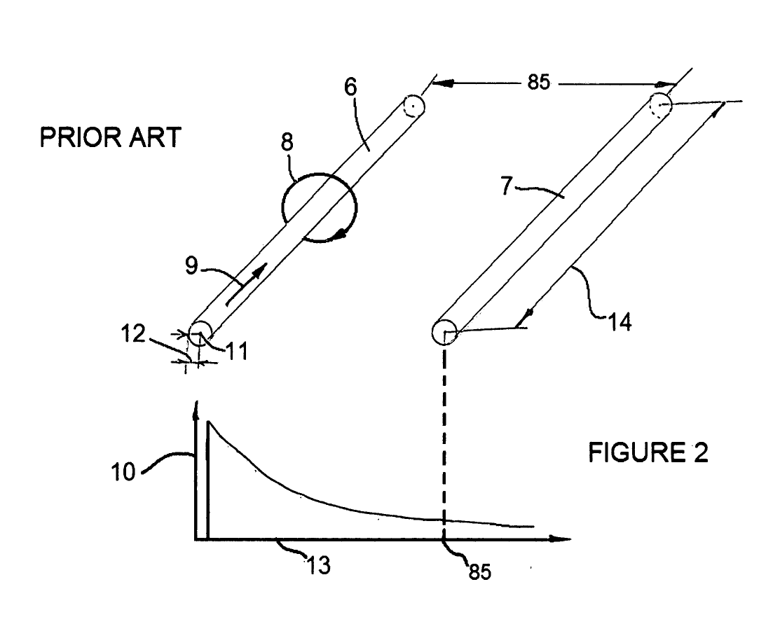

FIG. 3 is a simplified perspective diagram of a prior art planar transmitting loop in a spaced apart relationship with a planer receiving loop;

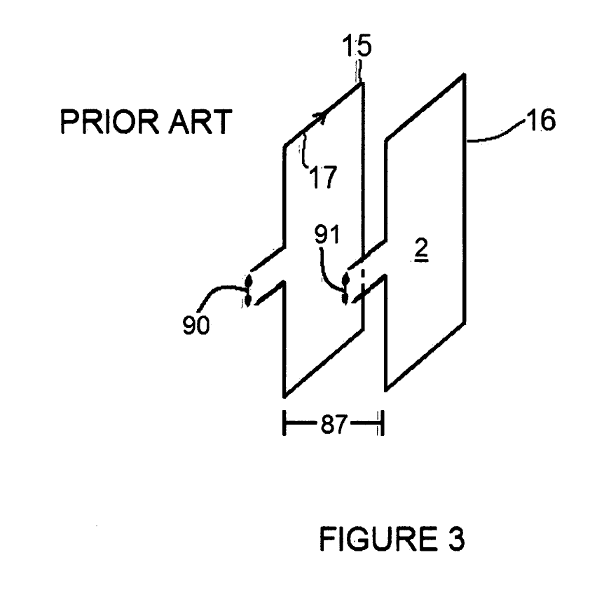

FIG. 4 is a prior art perspective diagram depicting the effect of a metal contaminant on the configuration depicted in FIG. 3;

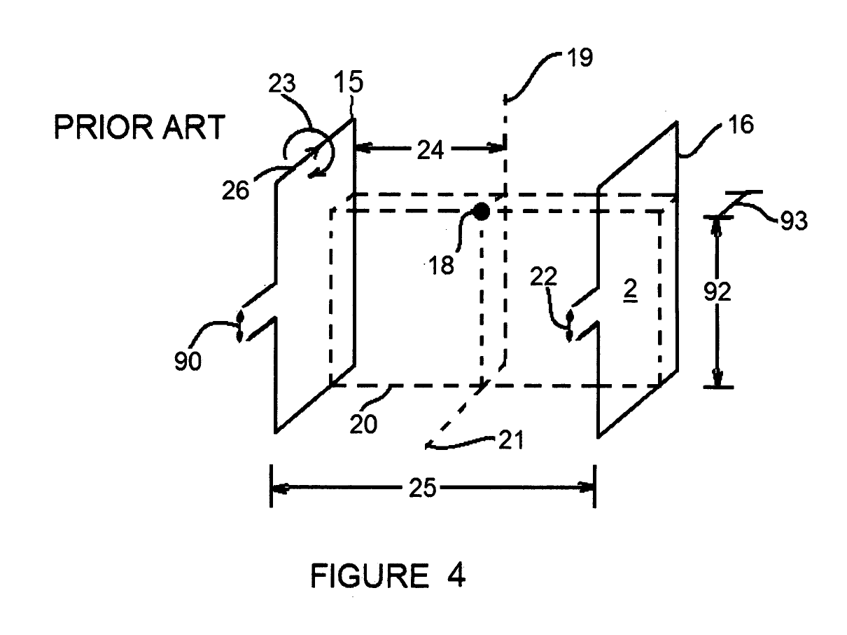

FIG. 5 is a simplified perspective diagram depicting the prior art configuration of a single transmitting loop surrounded by a receiving coil formed of two spaced apart loops;

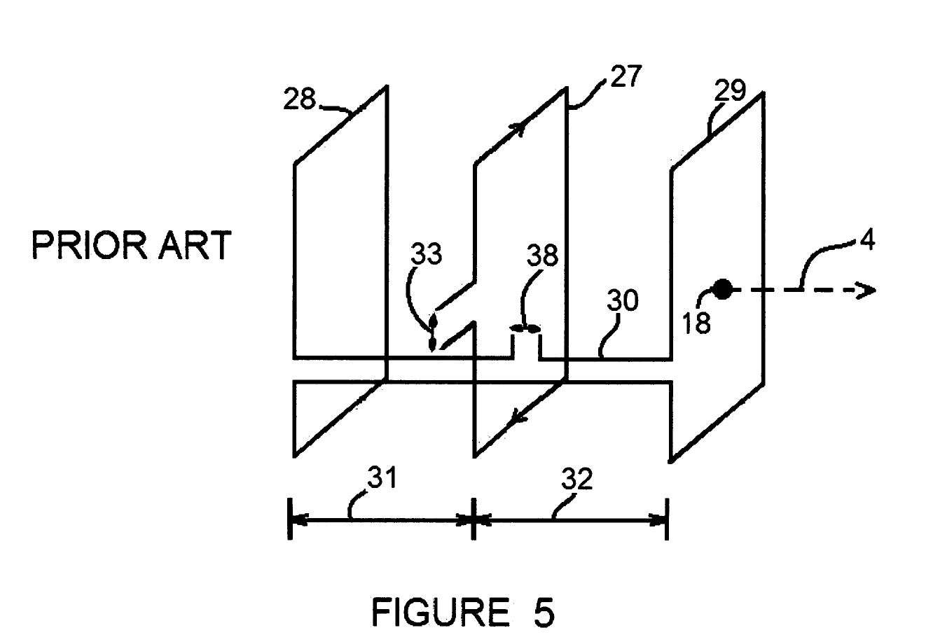

FIG. 6 is a prior art schematic diagram of the configuration depicted in FIG. 5;

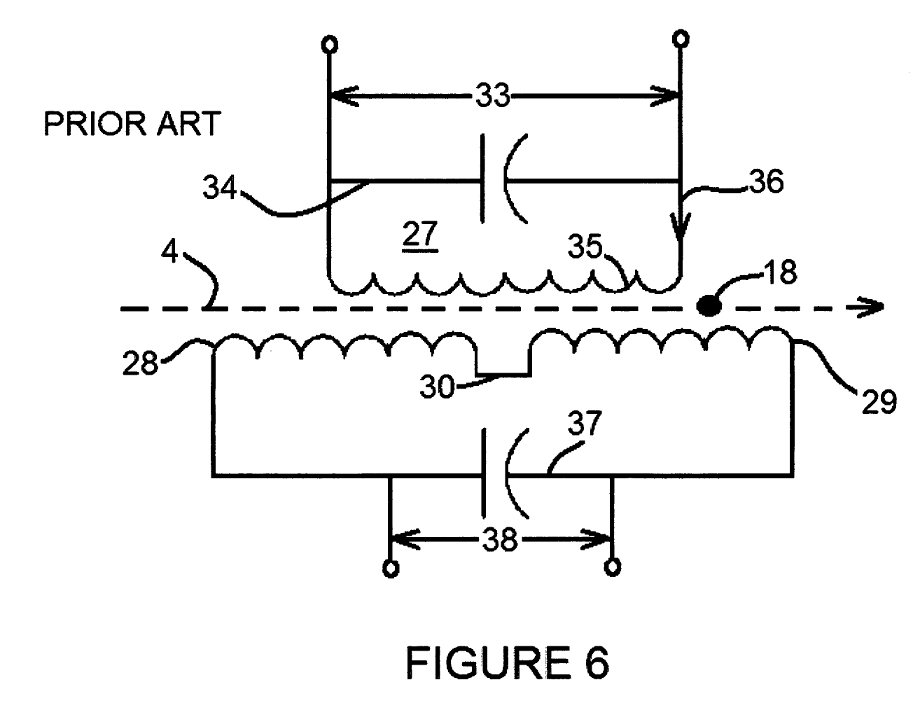

FIG. 7 is a prior art graph showing the effect of a metal contaminant on the configuration depicted in FIG. 6;

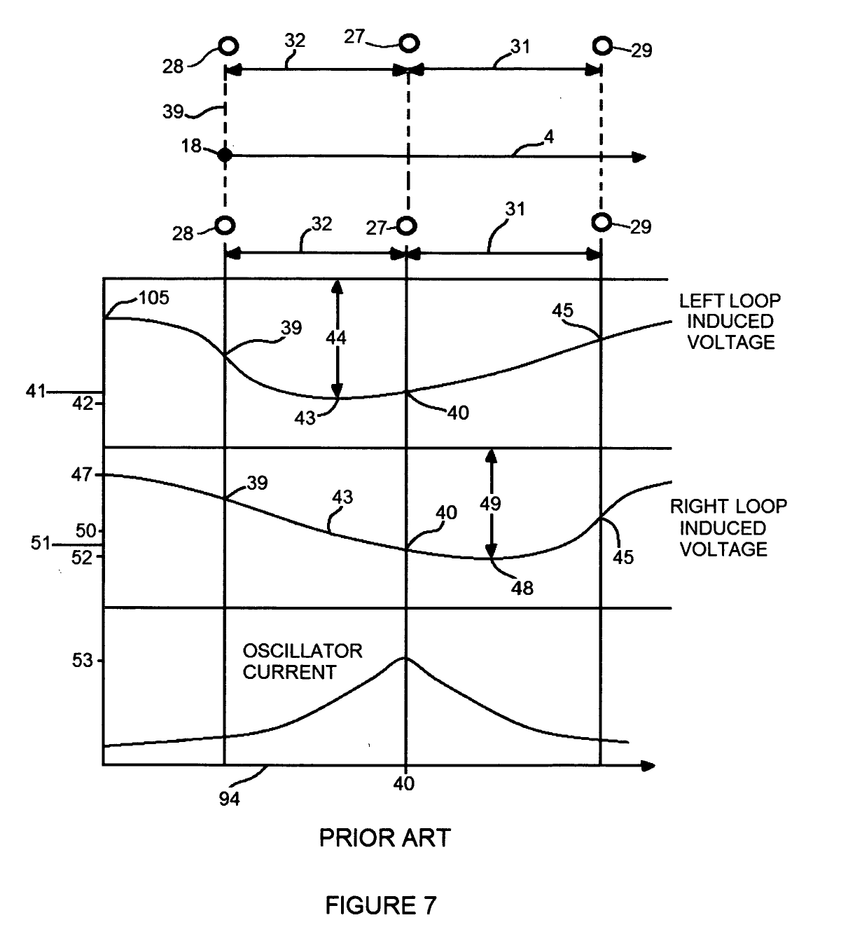

FIG. 8 is simplified perspective view of a dual parallel coil arrangement constructed according to the principles of the present invention;

FIG. 9 is a simplified perspective view of a serial additive coil arrangement constructed according to the principles of the present invention;

FIG. 10 is a flow chart depicting the design process used to create the coil arrangement depicted in FIG. 10; and

FIG. 11 is a simplified perspective view of an opposing series coil arrangement constructed according to the principles of the present invention.

### DETAILED DESCRIPTION OF THE PREFERRED EMBODIMENTS

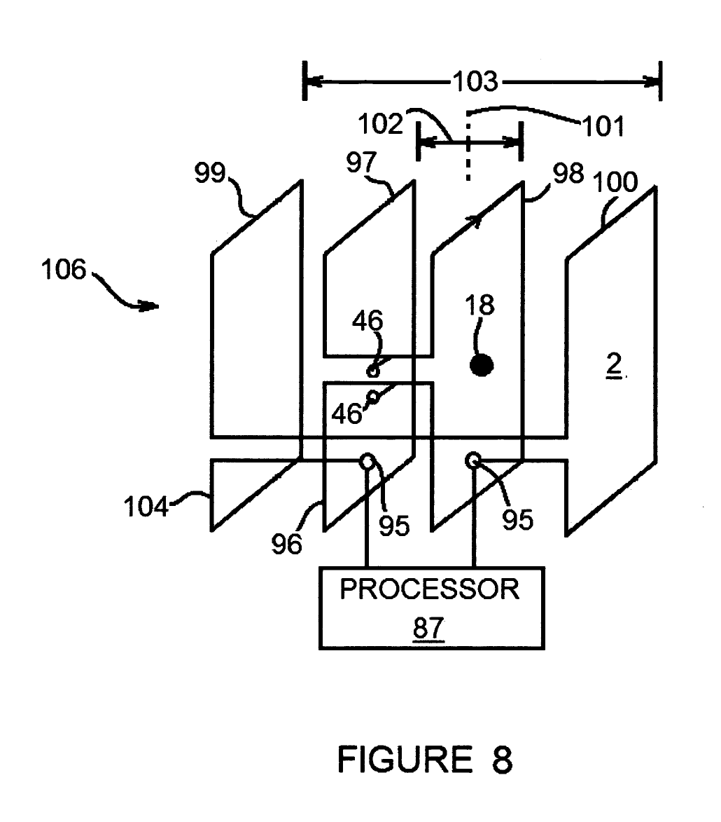

Referring to FIG. 8, the coil geometry of a metal detector constructed according to the principles of the present invention is shown generally at 106. The oscillator coil 96 is formed as two separate parallel interconnected loops 97 and 98 spaced around a geometrical center plane 101 by a total distance 102. The oscillator excitation voltage appearing across terminals 46 is applied simultaneously across both loops 43 and 44. The receiving or input coil 104 is formed as two individual loops 99 and 100 that are equidistant about the geometrical center plane 101 and which are spaced apart a total distance 103. In the case of a relatively large aperture 2 a single loop oscillator coil tends to have a relatively high inductance, and so the multiple parallel loop configuration is advantageous in reducing total inductance and thereby increasing total current in the oscillator coil 96 for a given aperture 2. The amount of induced voltage in the receiving loops 99 and 100 is increased by closely spacing the oscillator coil loop 97 to the receiving loop 99 and by closely spacing the oscillator coil loop 98 to the receiving loop 100. In order to reduce the absolute value of inductance of the oscillator coil further, the number of oscillator coil loops may be increased to more than two. The induced output voltage Vₒᵤₜ appearing across terminals 95 forwarded to processor 87 which performs an analysis to determine the presence of absence of a conductive contaminant 18. The desired coil spacing can be expressed as:

3.0>a/b>1.9, where [Equation 1]
“a” is the distance from the geometrical center plane 101 to the plane of either receiving or input loop;
“b” is the distance from the geometrical center plane 101 to the plane of either outermost oscillator loop; and
a=0.5√A, where “A” is the area of a single loop.

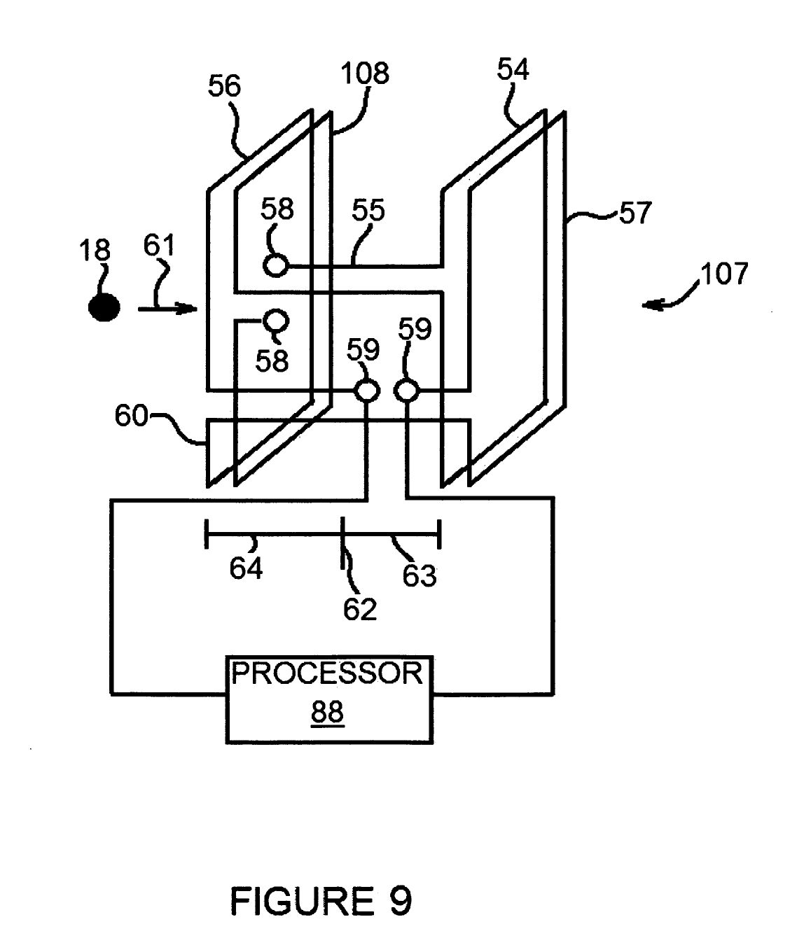

A second embodiment 107 of the invention is depicted in FIG. 9, in which the oscillator coil is a series coil 55 is formed in a distributed fashion, such as two separate loops 108 and 54, both being arranged such that their respective magnetic fields and resultant flux density are additive. The series coil arrangement increases the oscillator current by decreasing the inductance of coil 55 when a conductive contaminant 18 crosses the plane of the oscillator coil. When the conductive contaminant 18 crosses the plane defined, for example, by the first loop 108, the oscillator current is modified due to an alteration of the inductance of the first loop 108. When the contaminant is merely conductive but not ferromagnetic, the inductance of the first loop 108 is reduced, thus causing the oscillator current to increase as per Ohm's law. The second loop 54 is galvanically connected to the first loop 108 which is undergoing a reduction in inductance due to the presence of the contaminant 18, the effect of the oscillator coil current increase is perceived simultaneously by both the first input coil 56 as well as the second input coil 57. The receiving or input coil 60 is formed of the two separate input coils or loops 56 and 57 which are wound in serial opposition to each other. An increase in the oscillator coil current will cause an equal change in the value of the oscillator voltage Vᵢₙ appearing at terminals 58 for both loops 108 and 54 of the oscillator coil 55 which is cancelled in the value of the induced input coil output voltage Vₒᵤₜ appearing at terminals 59 because of the serial opposition of the two input coil loops 56 and 57. The full cancellation in the value of Vₒᵤₜ attributable to the change of the oscillator voltage that is caused by the presence of the contaminant 18 will only occur because of the change in the oscillator current that is attributable to the presence of the contaminant 18. The effect of the contaminant 18 on flux linkage still remains in the configuration 107, meaning that the input or receiving coil loop that is physically closest to the contaminant 18 will perceive both the effect of the increased oscillator current as well as the effect of the modified flux linkage, while the input or receiving coil loop that is physically farthest from the contaminant 18 will perceive only the effect of the modified oscillator current. The resultant value of Vₒᵤₜ appearing at terminals 59 will therefore include the effect of both the modified flux linkage and the modified oscillator current. The goal of metal detection is to increase the value of Vₒᵤₜ appearing at terminals 59 in the presence of the conductive contaminant 18. The value of Vₒᵤₜ appearing at terminals 59 in the geometry of coil configuration 107 is the summation of the voltage induced in receiving loop 56 and the voltage induced in the receiving loop 57. Vₒᵤₜ is forwarded to the processor 88 which performs an analysis to determine the presence or absence of a contaminant 18.

In the scenario, for example, where a contaminant 18 is approaching loops 56 and 57 as indicated by the arrow 61, the component of the induced voltage V attributable to the left loop 56 will tend to increase due to the effect of increased oscillator current and simultaneously will tend to decrease due to the effect of reduced flux linkage. The relative contribution of the modified flux linkage and the modified oscillator coil current will depend on the distance 63 of each oscillator loop plane from the geometric center 62 and the distance 64 of each input or receiving coil loop plane from the geometric center 62. The net resultant induced voltage value Vₒᵤₜ attributable to the left loop 56 is determined by the respective magnitude of each of the two effects. Simultaneously the component of the induced voltage Vₒᵤₜ attributable to the right loop 57 will tend to increase due to the effect of increased oscillator current due to the effect of reduced inductance in the left loop 108 of the oscillator coil 55.

By manipulating the loop spacing variables 63 and 64 a desired ratio of the relative contribution made to the value of Vₒᵤₜ appearing at terminals 59 which is attributable to flux linkage and the oscillator or excitation current can be achieved. The desired coil spacing for the configuration 107 can be expressed as:

1.0>a/b>0.95, where [EQUATION 2]
“a” is the distance from the geometrical center plane 62 to the plane of either receiving or input loop;
“b” is the distance from the geometrical center plane 62 to the plane of either outermost oscillator loop; and
a=√A, where “A” is the area of a single loop.

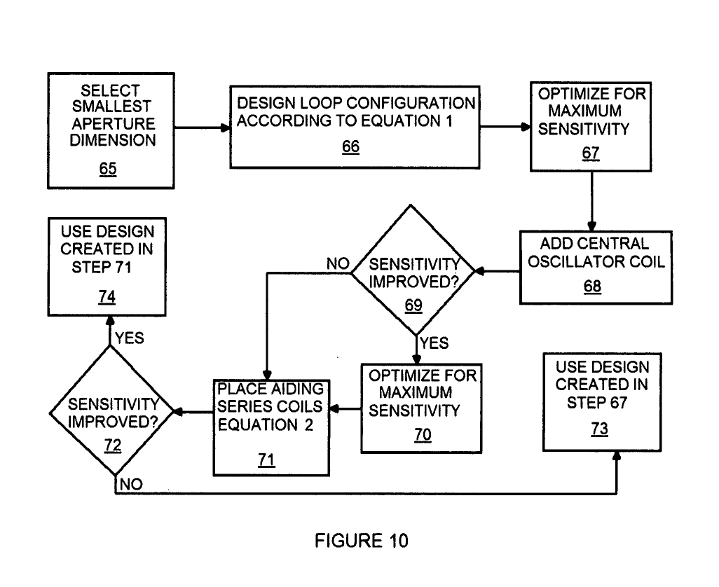

The generalized design process can be understood by reference to FIG. 10. The initial step 66 is to select the smallest aperture dimension that is needed for a particular real world metal detector enclosure based on the anticipated environment in which the metal detector will be used. Given the aperture size, at step 66 the coil configuration 106 is designed based on the parameters of Equation 1, with the resultant design being optimized at step 67 to achieve maximum sensitivity or a maximum value of Vₒᵤₜ for a given contaminant size, conductivity and geometry. The next step 68 is to add a single additional third oscillator coil loop that is equidistantly placed between the receiving loops 48 and 49. At step 69 the addition of a single loop oscillator coil is evaluated. If the single coil configuration result improves metal detector sensitivity, the design is optimized for maximum sensitivity at step 70, and the design process then proceeds to step 71. If no improvement in sensitivity is obtained by substituting the single loop at step 69, the design process proceeds directly to step 71 which substitutes aiding series loops for the oscillator coil according to Equation 2. If sensitivity is improved, the design process ends at step 74 by using the design based on Equation 2. If no sensitivity improvement is obtained, the design obtained at step 67 based on Equation 1 is utilized.

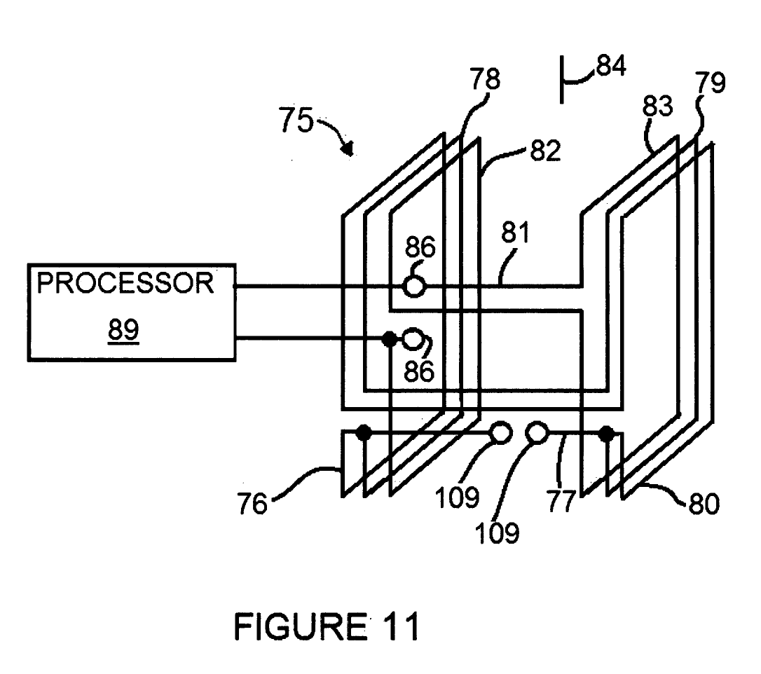

Referring to FIG. 11, an additional configuration 75 of the present invention is described. An input oscillator voltage is applied across the terminals 109 of the oscillator coil 77 which is formed of at least four substantially planar loop elements, such as, for example, outer left loop 76, inner left loop 78, inner right loop 79 and outer right loop 80. The inner left loop 78 and outer left loop 76 are in parallel with each other, as are the outer right loop 80 and the inner right loop 79. The pair of left hand loops 76 and 78 is connected in series opposition to the right hand loops 79 and 80. The input or receiving coil 81 is formed to include a left loop 82 and a right loop 83, with each receiving coil loop being placed equidistantly relatively closer to the geometrical center plane 84 than any of the oscillator coil loops. The configuration 75 simultaneously utilizes the flux linkage modification between the oscillator coil 77 and the receiving coil 81 as well as the modification of oscillator coil current in the presence of a contaminant 18 to supply an output signal across terminals 86 to the processor 89. The desired coil spacing for the configuration 75 can be expressed as:

1.0>c/a>0.90, where

1.0>a/b>0.85, [EQUATION 3]
“a” is the distance from the geometrical center plane 84 to the plane of either inner most oscillator coil loop;
“b” is the distance from the geometrical center plane 84 to the plane of the adjacent outermost oscillator loop; and
“c” is the distance from the geometrical center plane 84 to the plane of either receiving coil loop.

The foregoing improvements embodied in the present invention are by way of example only. For example, the various coil configurations disclosed for the various embodiments may be advantageously combined in various situations, such as, for example, when the parameters of the contaminant 18 expected to be encountered are well known and predictable within relatively narrow constraints. Those skilled in the metal detecting field will appreciate that the foregoing features may be modified as appropriate for various specific applications without departing from the scope of the claims.

I claim:

1. A metal detector for detecting the presence of a contaminant within a product, the metal detector being adapted to transport the product through a region intersecting an electromagnetic field having a flux density, comprising:
(a) an oscillator coil generating the electromagnetic field, the oscillator coil conducting an oscillator coil current, the oscillator coil being excited by an oscillator voltage;
(b) an input coil, the input coil being mounted in a region adjacent to the oscillator coil so as to be linked to the electromagnetic field generated by the oscillator coil, the input coil thereby having a flux linkage with the electromagnetic field, the input coil possessing a quantifiable voltage induced by the electromagnetic field, the quantifiable voltage varying in response to both a modification of the oscillator current and a modification the flux linkage that occurs when the contaminant is present within the product;
(c) a processor, the processor being adapted to detect the presence of a contaminant within the product based on a magnitude of the quantifiable voltage induced within the input coil by the electromagnetic field.

2. The metal detector according to claim 1, in which the oscillator coil further comprises a series coil formed as two separate substantially planar loops, each of the two separate substantially planar loops being symmetrically located about a geometrical center plane, both of two separate loops being oriented so that their respectively generated magnetic fields and their resultant flux density are additive.

3. The metal detector according to claim 2, wherein the series coil formed as two separate loops increases the oscillator coil current by decreasing oscillator coil inductance when a conductive contaminant crosses a plane of an oscillator coil loop.

4. The metal detector according to claim 3, wherein the oscillator current is modified when a conductive contaminant crosses the plane of an oscillator coil loop in response to an alteration of inductance of the oscillator coil loop.

5. The metal detector according to claim 4, wherein the input coil is formed of two separate loops, each of the two separate loops defining a plane, the two separate loops being interconnected in serial opposition to each other.

6. The metal detector according to claim 5, wherein an increase in the oscillator coil current causes an equal change in the oscillator voltage for each separate oscillator coil loop, the equal change in the oscillator coil voltage for each separate oscillator coil loop being cancelled so as not to affect the quantifiable input voltage induced in the input coil due to the serial opposition of the two separate loops of the input coil.

7. The metal detector according to claim 6, wherein each of the two separate loops of the oscillator coil is located so as to be adjacent to one of the two separate loops of the input coil.

8. The metal detector of claim 7, the separate input coil loop that is physically closest to a contaminant is affected by an increased oscillator current as well as a modified flux linkage, whereas the separate input coil loop that is physically farthest from a contaminant is affected only by a modified oscillator current.

9. The metal detector of claim 8, wherein desired coil spacing between an input coil loop and an oscillator coil loop is expressed as:
1.0>a/b>0.95, where
“a” is the distance from the geometrical center plane to either input loop;
“b” is the distance from the geometrical center plane to either outermost oscillator loop; and
a=√A, where “A” is an area of a single loop.

10. The metal detector of claim 1, in which the oscillator coil further comprises a series coil formed at least two pairs of separate substantially planar loops, each pair of the separate substantially planar loops being symmetrically located about a geometrical center plane, each pair of the separate loops being oriented so that their generated magnetic fields and their resultant flux density are in series opposition to any other pair of separate substantially planar loops.

11. The metal detector of claim 10, wherein the input coil is formed of two separate planar loops, each of the two separate loops defining a plane, each of the two separate planar loops being adjacent to one pair of the separate substantially planar loops of the oscillator coil, each of the two separate planar loops residing at a location that is closer to the geometrical center plane than any oscillator coil loop.

12. The metal detector of claim 11, wherein desired coil spacing is expressed as:
1.0>c/a>0.90, where
1.0>a/b>0.85,
“a” is a distance from the geometrical center plane to an inner most oscillator coil loop;
“b” is a distance from the geometrical center plane to an adjacent outermost oscillator loop; and
“c” is a distance from the geometrical center plane to an input coil loop.

13. The metal detector of claim 12, wherein the oscillator coil further comprises:
(a) an outer left loop;
(b) an inner left loop;
(c) an inner right loop; and
(d) an outer right loop, wherein the inner left loop and the outer left loop are in parallel with each other, the outer right loop and the inner right loop are in parallel with each other, and all left hand oscillator coil loops are connected in series opposition to all right hand oscillator coil loops.

14. The metal detector of claim 12, wherein the oscillator coil further comprises:
(a) first, second and third left loops, the first, second and third left loops being formed as substantially planar parallel loops residing in a spaced apart relationship, the first, second and third left loops being interconnected in a parallel relationship with each other;
(b) first, second and third right loops, the first, second and third right loops being formed as substantially planar parallel loops residing in a spaced apart relationship, the first, second and third right loops being interconnected in a parallel relationship with each other, wherein all left hand oscillator coil loops are connected in series opposition to all right hand series opposition coil loops.

15. A metal detector adapted to detect the presence of a conductive contaminant within a product by utilizing the combined effects of modified flux linkage and oscillator excitation current while the product is transported through an electromagnetic field having a quantifiable flux density, comprising:
(a) an oscillator coil conducting the oscillator excitation current, the oscillator coil being formed as first and second separate parallel interconnected planar loops spaced equidistantly on either side of a geometrical center plane;
(b) an input coil formed as first and second planar loops spaced equidistantly on either side of the geometrical center plane, wherein the first planar loop of the oscillator coil is adjacent to the first planar loop of the input coil, and the second planar loop of the oscillator coil is adjacent to the second planar loop of the input coil.

16. The metal detector of claim 15, wherein the desired coil spacing is expressed as:
3.0>a/b>1.9, where
“a” is a distance from the geometrical center plane to one of the two separate substantially planar input coil loops;
“b” is a distance from the geometrical center plane to an outermost oscillator loop; and
a=0.5√A, where “A” is an area of an oscillator loop.

17. The metal detector of claim 16, further comprising third and fourth separate parallel interconnected planar loops spaced equidistantly on either side of a geometrical center plane, the third and fourth planar loops being interconnected in a parallel relationship with the first and second separate parallel interconnected planar loops.

18. A method of utilizing the combined effects of modified flux linkage and oscillator excitation current in a radio frequency metal detector adapted to detect the presence of a conductive contaminant within a product while the product is being transported through an electromagnetic field having a quantifiable flux density, comprising the steps of:
(a) identifying a smallest usable dimension of an aperture within the metal detector through which the product will be transported;
(b) defining a geometrical center plane within the aperture;
(c) forming a parallel wound oscillator coil so as to surround the aperture as two separate planar loops; and
(d) forming a series would input coil as two separate planar loops so as to surround the aperture according to the formula:
3.0>a/b>1.9, where
“a” is a distance from the geometrical center plane to a planar input loop;
“b” is a distance from the geometrical center plane to the plane of an oscillator loop; and
a=0.5√A, where “A” is the area of a single planar input loop.

19. The method of claim 18, further comprising the steps of:
(a) maximizing an input coil output voltage in response to the presence of a conductive contaminant;
(b) placing a third parallel interconnected planar oscillator coil loop in a coplanar relationship with the geometrical center plane;
(c) evaluating an input coil output voltage in response to the presence of a conductive contaminant after placement of the third parallel interconnected planar oscillator loop;
(d) substituting a series additive oscillator loop for the parallel wound oscillator coil according to the formula
1.0>a/b>0.95, where
“a” is a distance from the geometrical center plane to the plane of an input coil loop;
“b” is a distance from the geometrical center plane to an oscillator coil loop; and
a=√A, where “A” is an area of an input coil loop.

20. The method of claim 19, further comprising the steps of:
(a) evaluating a maximum input coil output voltage in response to the presence of a conductive contaminant for each coil geometry; and
(b) selecting the coil geometry that generates the maximum input coil output voltage in response to the presence of a conductive contaminant.
